(19) United States
(12) Patent Application Publication
(10) Pub. No.: US 2020/0018663 A1
(43) Pub. Date: Jan. 16, 2020

(54) Methods and Apparatus for Leak Testing

(71) Applicants: Arthur Nelson Hoffmann, III, Amityville, NY (US); Michael Charles Oldrey, Medford, NY (US); Glenn Fricano, Islip, NY (US)

(72) Inventors: Arthur Nelson Hoffmann, III, Amityville, NY (US); Michael Charles Oldrey, Medford, NY (US); Glenn Fricano, Islip, NY (US)

(21) Appl. No.: 16/036,768

(22) Filed: Jul. 16, 2018

(51) Int. Cl. G01M 3/20; G01M 3/00; G01M 3/28

(52) U.S. Cl. CPC G01M 3/205; F28D 7/106; G01M 3/2846; G01M 3/007

(57) ABSTRACT

A method for leak testing components including loading a subject component to be tested into a vacuum chamber; securing the subject component by a tooling that seals the inlets of two Circuits; selectively setting a series of valves to provide access to vacuum systems, or to a charge system that can supply tracer gas to the Circuits; pumping a main test chamber to provide a vacuum level suitable for sampling by a mass spectrometer; testing the subject component for continuity ensure there are no blockages within the subject component; charging Circuit 1 with a tracer gas to a desired test pressure; sensing via a mass spectrometer for tracer gas; selectively setting valves to seal off Circuit 2 from a vacuum test chamber; pressurizing Circuit 2 with a tracer gas to a desired test pressure; evacuating the Circuits of the tracer gas; and unloading the subject component from the vacuum chamber.

### CROSS REFERENCE TO RELATED APPLICATIONS

This application claims priority from U.S. Pat. App. No. 62/604,663 entitled Methods and Apparatus for Mass Spectrometer Vacuum Helium Leak Testing Co-Axial Nest Parts such as Internal Heat Exchangers filed on 17 Jul. 2017, wherein the current application expressly incorporates by reference the full spirit and scope of the prior application(s).

### BACKGROUND OF THE INVENTION

This invention relates to providing a method and apparatus for leak testing of subject components.

### PRIOR ART

There is a longstanding need in the industry to improve quality while improving production times. However, the existing systems and devices fail to address the issue or provide a system and device that tests for leakage from an internal tube nested within an outer tube and testing the leak integrity of the inner tube beyond the co-axial section along with leak testing the outer tube leak integrity in one testing sequence without the need to remove the part being tested from a hard-vacuum chamber. That is, the prior art requires the removal of the part being tested between tests, unlike the current invention set forth hereinbelow.

### SUMMARY OF INVENTION

An objective of the present invention includes providing a system having a typical tracer gas vacuum test station capable of leak testing co-axial/IHX hose assemblies to conform to rigorous environmental and efficiency standards, wherein IHX is defined as internal heat exchanger.

Another objective of the present invention includes providing a system to ensure that parts or assemblies such as co-axial circuitry in IHX hoses for example, that have established limits on leakage rates of gases or liquids both internal and external, can be accurately and effectively measured in a low cost production manner.

A still further objective of the present invention includes providing a system wherein high volume applications such as automotive air conditioning systems that employ potentially environmentally unfriendly refrigerants (green house gases) it becomes necessary to identify those parts that fail the required leakage specifications.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a Generic Vacuum Mass Spectrometer based leak detection system with tracer gas charge system and tooling for securing co-axial circuitry assemblies within the vacuum chamber for leak testing;

FIG. 2 illustrates a preferred embodiment of the present invention, having generic inputs and outputs for testing sequences;

FIG. 3 illustrates the present invention's sequence for co-axial/IHX circuitry hose structures and where the Mass Spectrometer will be looking for a signal from during the leak testing of the subject component being tested; and

FIG. 4 illustrates the present invention continued leak test from FIG. 3 of Circuit 2 to the environment.

### DETAILED DESCRIPTION OF INVENTION

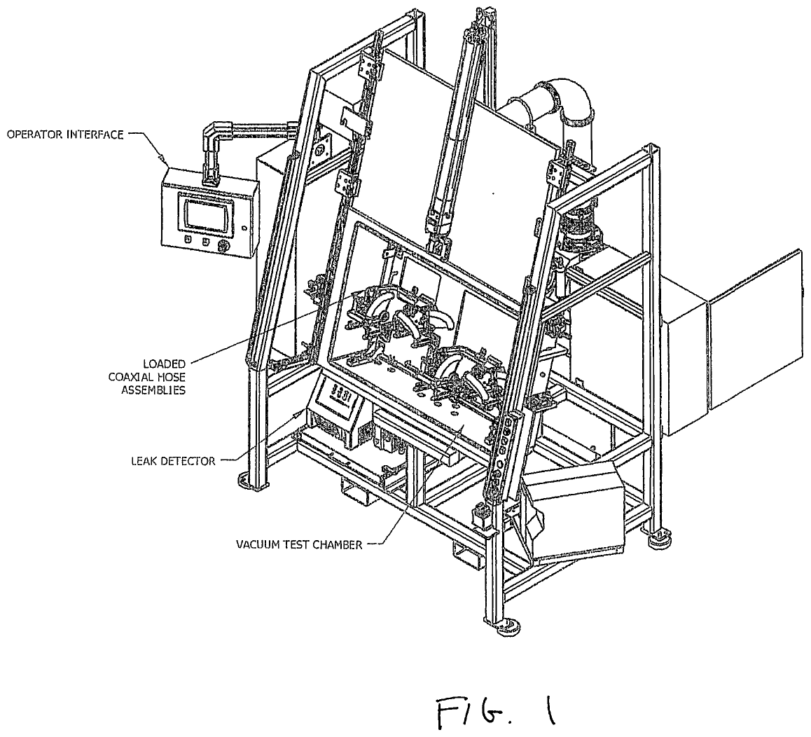

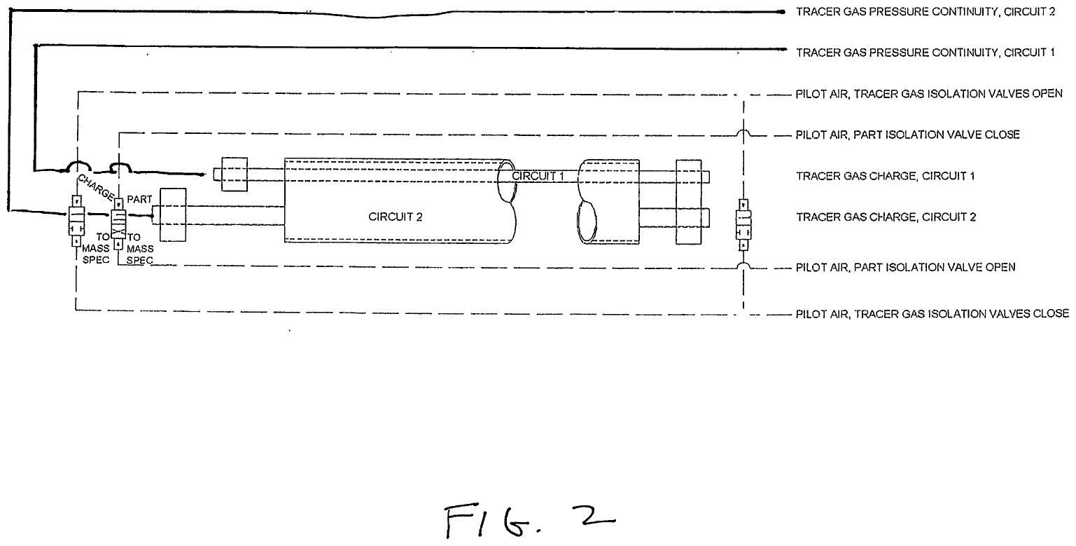

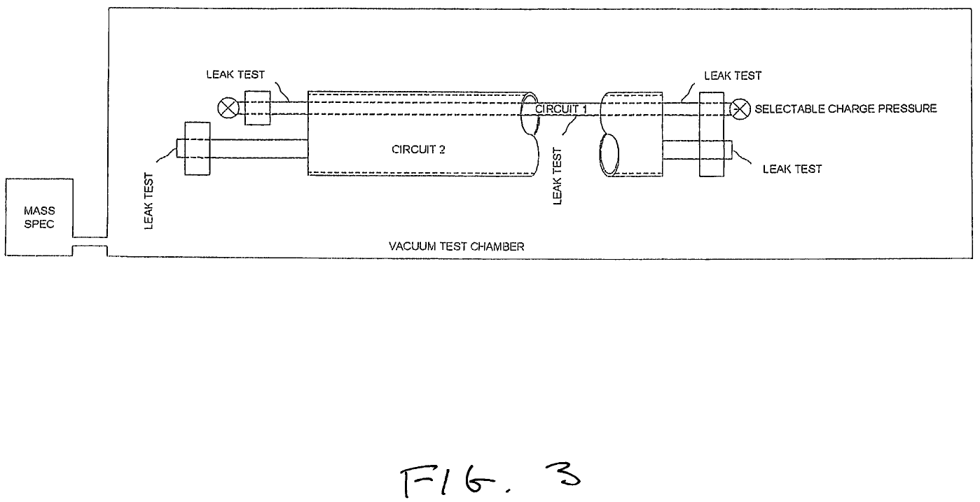

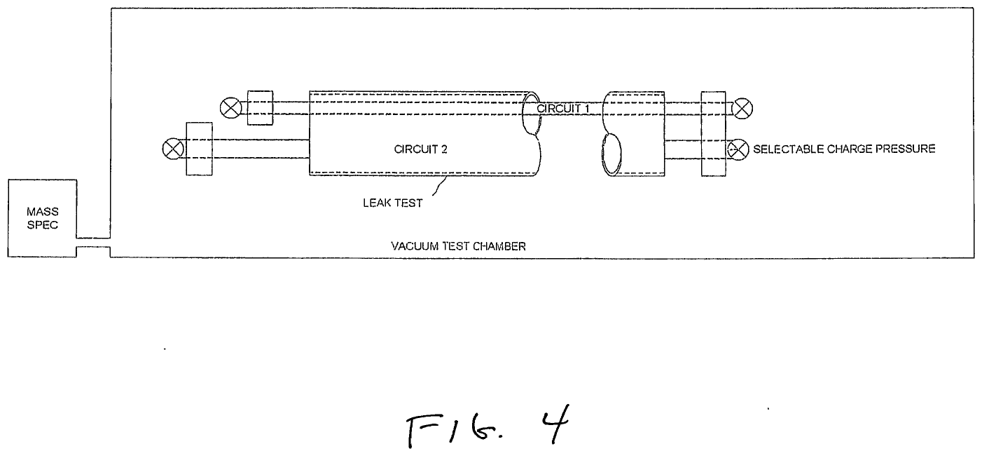

Referring generally to FIGS. 1 to 4, herein below, the figures illustrate the hardware and process steps needed to be able to leak test a subject component, such as a co-axial or nested tube assemblies to measure the leak integrity of the assembly. The test sequence comprises the following steps and uses IHX hose assemblies as the subject component to describe the test flow.

First, the hose assembly is loaded into a vacuum chamber and secured by tooling that seals the inlets and outlets of both Circuit 1 and Circuit 2. Wherein the tooling is a frame that the subject component is installed into, and which generally seals the subject component shut using connections that closely mimic, or are identical to, the connections used in the customer's final application. These connections are often designed with input from documentation provided by the customer. The connections are typically held closed by pneumatic cylinders or manually-operated mechanical clamps. The tooling is very closely related to the type of tooling that would be used in the prior art of testing a single isolated circuit.

Second, through a series of valves, all ends of the subject component, e.g., an IHX hose assembly, can be selectively opened to one of a plurality of modes. In the preferred embodiment it can be selectively opened to a mode comprising a (i) vacuum system dedicated for a given circuit, which is separate and distinct from the vacuum test chamber or (ii) to a charge system that can supply tracer gas to selected from the following (1) only Circuit 1, (2) only Circuit 2, or (3) both Circuit 1 and Circuit 2 simultaneously. Again, there is a vacuum system for each Circuit, which are entirely separate from each other and from the main vacuum chamber.

Once the subject component is installed into the tooling and sealed, the selected circuit vacuum system evacuates the room air that is initially trapped in the subject component. Once the subject component is evacuated, it is then charged with tracer gas, e.g., helium.

Third, the test chamber is evacuated by pumping to provide a vacuum level suitable for sampling by a mass spectrometer. In the preferred embodiment, the vacuum chamber comprises a stainless steel box that the tooling sits inside. It is evacuated by a large vacuum pump that reaches a low vacuum level, around the range of 10 to 50 milliTorr. The Circuits each have dedicated vacuum pumps of their own which are typically much smaller in size and capacity, given the less stringent vacuum requirements and the lesser volume of the parts relative to the chamber. The vacuum pumps are all separate and independent, to preclude cross-contamination between the Circuits.

Fourth, the subject component can be tested for continuity within both Circuit 1 and Circuit 2 to ensure there are no blockages within the assembly. The test for continuity is performed with the tracer gas: each circuit is connected to the tracer gas source at one end (proximal end), and at the other end (distal end) is connected to a pressure transducer. If the pressure transducer returns a reading at the charge pressure, then the circuit has successfully been charged and there are no internal blockages. Contrastingly, if the transducer reads zero or does not reach the charge pressure fast enough, it indicates an internal blockage that restricts or entirely cuts off fluid flow through the circuit. In practice, blockages refers to a blockage between one end of the circuit and the other, which would prevent coolant flow in end use of the subject component, e.g., the IHX.

Fifth, Circuit 1 is now charged to test pressure with a tracer gas (for example, helium) wherein the tracer gas can be sensed by a mass spectrometer that can be exposed to the circuit once the valves are opened to the vacuum chamber, thereby permitting egress of any fugitive tracer gas entering the vacuum chamber. In the preferred embodiment where IHX hoses are the subject component, a typical charge pressure is over 200 PSI. Circuit 2 is left open to the vacuum test chamber so that leaks from Circuit 1 to the internal assembly of Circuit 2 are enabled to be detected by the mass spectrometer tuned to the charged tracer gas, e.g., helium. In this setting, both Circuit-1-to-exterior, and Circuit-1-to-Circuit 2 leaks can be detected. These are two of the three possible leak “locations” in a two-circuit nested part. The third possible “location” is Circuit-2-to-exterior. The necessity of the IHX process hinges on the fact that if both circuits were charged simultaneously, a mass spectrometer connected to the vacuum chamber could only detect Circuit-1-to-exterior and Circuit-2-to-exterior leaks; however, if a Circuit-1-to-Circuit-2 leak existed, it would be trapped behind the inlet and outlet seals, and thus invisible to the vacuum chamber and the mass spectrometer. The machine cannot automatically differentiate between a Circuit-1-to-exterior leak and a Circuit-1-to-Circuit-2 leak; both will appear indistinguishable during the automatic cycle. However, the leak testing machine could be operated in manual mode to charge both circuits simultaneously and by process of elimination determine the general “location” of a stage one failure.

Moreover, due to the two-stage nature of the test, the leak testing machine can differentiate a Circuit-2-to-exterior leak from the other two varieties. Although the leak testing machine does not automatically pinpoint a precise location on the subject component, the leak testing machine can be operated in manual mode to charge the part with the chamber open, at which point the leak detector's sniffing wand could be used to chase the leak down by hand. At this moment in time, the subject component, e.g., IHX hoses are individually inexpensive enough as to not warrant repair; rather, if the customer is trying to manually pinpoint a location, it is generally in hopes of fixing any specific manufacturing process that might be causing the leaks. It is conceivable that dual-circuit subject components other than IHX hoses might be worth repairing.

Sixth, Circuit 2 is then sealed off from the vacuum test chamber and pressurized with the tracer gas e.g., helium, to the required test pressure. It should be noted, that the test pressure of Circuit 2 maybe different than that of Circuit 1, as defined by the customer. However, often times the tested pressure for Circuit 2 is the same as Circuit 1. Nevertheless, any and all leaks from the external assemblage of Circuit 2 will also be detected by the mass spectrometer, should there exist any fugitive emissions of the tracer gas.

Seventh, after test completion, both Circuit 1 and Circuit 2 are evacuated by venting and pumping out prior to unloading of the hose assembly in order to minimize and optimally eliminate any residual tracer gas in the vacuum chamber. It should be noted, that the default operation of the leak testing machine is to vent tracer gas into a vent line that leads outside the plant, so as not to contaminate the leak testing machine's immediate surroundings. Because helium is inert and (aside from test contamination risks) almost entirely benign, it is environmentally safe to vent arbitrarily large quantities of helium into the atmosphere. Some customers use helium recovery machines that capture and recondition used helium to be recycled for future tests, and it is envisioned that the preferred embodiment can be modified to include the helium recovery option. Recovery machines are about as expensive as the primary test equipment, so their purchase and use is determined by the quantity of helium used by the customer, the current cost of helium, and the projected future cost of helium. It should be noted, that the post-test treatment of the subject component and the tool circuit is crucial to the success of subsequent tests. i.e., if all residual tracer gas is not eliminated at this juncture, a “false leakage indication” may be detected on the subsequent test.

All the above referenced patents; patent applications and publications are hereby incorporated by reference. Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and is not limiting. The invention is limited only as defined in the claims and equivalents thereto.

1. A method for leak testing components comprising the steps of:
loading a subject component to be tested into a vacuum chamber;
securing the subject component by a tooling that seals the inlets of Circuit 1 and Circuit 2;
selectively setting a series of valves to provide access to (a) vacuum systems, or (b) to a charge system that can supply tracer gas to (i) Circuit 1, (ii) Circuit 2, or (iii) both Circuit 1 and Circuit 2 simultaneously;
evacuating a test chamber to provide a vacuum level suitable for sampling by a mass spectrometer;
testing the subject component for continuity within both Circuit 1 and Circuit 2 to ensure there are no blockages within the subject component;
charging Circuit 1 with a tracer gas to a desired test pressure;
sensing via a mass spectrometer for tracer gas;
selectively setting valves to seal off Circuit 2 from the vacuum test chamber;
pressurizing Circuit 2 with a tracer gas to a desired test pressure;
evacuating Circuit 1 and Circuit 2 of the tracer gas; and
unloading the subject component from the vacuum chamber.
